(19) United States
(12) Patent Application Publication
(10) Pub. No.: US 2005/0239327 A1
(43) Pub. Date: Oct. 27, 2005

(54) Device for electronically contacting an electrically conductive part of a high-frequency system

(76) Inventor: Thomas Cantz, Stafa (CH)

Correspondence Address: THE WEBB LAW FIRM, P.C., 700 KOPPERS BUILDING, 436 SEVENTH AVENUE, PITTSBURGH, PA, 15219, US

(21) Appl. No.: 10/517,579

(22) PCT Filed: May 12, 2003
(86) PCT No.: PCT/CH03/00301

§ 371 Date: Dec. 9, 2004

(30) Foreign Application Priority Data
Jun. 10, 2002 (EP) 02 405 470.2

(51) Int. Cl. H01R 9/05

(52) U.S. Cl. 439/578

(57) ABSTRACT

A high-frequency component includes at least one metallic supporting element which is made of bronze, particularly cast bronze. The proportion of zinc is less than 18 percent by weight, preferably less than 12 percent by weight. The component is substantially more resistant in an aggressive atmosphere, especially to ammonia and sulfur compounds, than brass.

The invention relates to a device according to the precharacterizing clause of claim 1.

Steel that is stainless in accordance with the international standard “Fed. Spec. QQ-S-764” (stainless steel) is used in high-frequency engineering for devices for electrically contacting coaxial cables, for example. However, this steel causes passive intermodulation products and therefore cannot be used in many high-frequency applications. As an alternative to the steel mentioned, brass in accordance with the standard “QQ-B-626” is also used. However, brass has the disadvantage of stress crack corrosion and must therefore be additionally protected from aggressive environmental influences by an insulating strip or a shrink-fit tube when devices are used outdoors and in particular when they are installed in humid, contaminated surroundings. This causes additional costs to be incurred for installation.

The invention is based on the object of providing a device of the stated type which is also largely resistant to stress crack corrosion in an aggressive ambient atmosphere, but nevertheless is comparable to brass with respect to the electrical properties, machinability and electroplatability and produces negligible passive intermodulation products.

The object is achieved in the case of a high-frequency component of the stated type by the supporting element being produced from bronze, in particular cast bronze. Investigations have shown that bronze, and in particular cast bronze, is significantly more stable than brass with respect to aggressive media, and in particular ammonia and sulfur compounds. Bronze is significantly less susceptible to stress crack corrosion, in particular under mechanical stresses, including under internal stresses in the stated aggressive media. The resistance in aggressive media is even ensured when the components are not protected by shrink-fit tubes, adhesive tape and the like and are consequently directly exposed to the ambient atmosphere. The use of bronze as a contact part in the case of electrical components is known per se. However, the aforementioned object is not achieved thereby. The only aim here is to obtain better contact.

It is regarded as a major advantage of the high-frequency component according to the invention that bronze can essentially be processed just as inexpensively as brass. In particular, bronze alloys can be machined and in this way it is possible in particular to produce connectors inexpensively. Replacing brass with bronze, in particular cast bronze, is consequently possible essentially without additional costs.

The high-frequency component is in particular and preferably a coaxial connector or a lightning protection component.

It has been found that the resistance of the high-frequency component according to the invention under exposure to aggressive media is particularly great whenever the proportion of zinc is less than 18% by weight, preferably less than 12% by weight. Particularly high resistance is obtained whenever the proportion of zinc is less than 7% by weight, preferably 6% by weight. A particularly preferred alloy has the composition CuZn6Sn4Pb3.

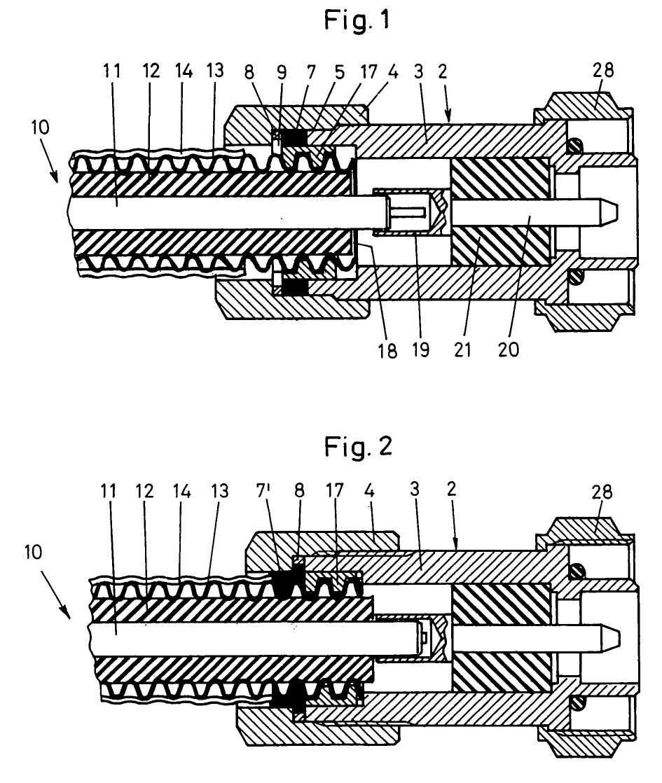

An exemplary embodiment of a high-frequency component according to the invention is explained below on the basis of FIGS. 1 and 2, which respectively show a section through a coaxial connector according to the invention.

According to FIGS. 1 and 2, the high-frequency component is a coaxial connector 2, which has a housing 3 to which a coaxial cable 10 is detachably fastened by a nut 4. The coaxial cable 10 has, in a way known per se, an inner conductor 11, an insulator 12, a corrugated sheath 13 as an outer conductor and a sleeve 14. The inner conductor 11 is connected by means of a connecting sleeve 19 to a connector pin 20, which is surrounded by an insulator 21. The coaxial connector 2 is screwed by a further nut 28 to a connector part that is not shown here.

In FIG. 1, the nut 4 has not yet been screwed completely onto the housing 3. During the further screwing-on of the nut 4, up to the position shown in FIG. 2, a sealing composition 7, for example comprising an elastomer, is partly displaced into an annular space 9 and thereby seals off from the outside a threaded ring 17, which is screwed onto the corrugated sheath 13. As can be seen, the front end of the corrugated sheath 13 is deformed during the screwing-on of the nut 4. A ring 8 limits the screwing-in depth of the nut 4.

The two nuts 4 and 28 and the housing 3 are produced from bronze, in particular cast bronze. The outwardly protected threaded ring 17 may be produced as usual from brass. The two nuts 4 and 28 are preferably improved on their surfaces, for example silver-plated, whereby the contact resistance is improved. The connector pin 20 is likewise preferably produced from bronze, in particular cast bronze, and improved on its surface, in particular silver-plated.

The bronze preferably has a comparatively low proportion of zinc. This is preferably less than 18% by weight, preferably less than 12% by weight. A particularly preferred bronze has a zinc proportion of less than 7% by weight.

The copper-tin-zinc cast alloy that is used is preferably a multialloy bronze with lead and has, for example, the composition CuZn6Sn4Pb3.

The device according to the invention is, for example, part of a high-frequency lightning protection component, a component of an outdoor antenna, of a power divider or of a high-frequency coupler.

The bronze used consequently forms supporting parts of the coaxial connector 1 which are exposed to the ambient atmosphere and are under mechanical stress. It is also resistant under mechanical stress in corrosive media, for example ammonia and sulfur compounds. The resistance relates in particular to resistance to stress crack corrosion, which can lead to rupturing of the components. The connecting part 1 is therefore suitable in particular for outdoor applications, for example for outdoor antenna systems which are permanently exposed to the environmental atmosphere. Additional protection is consequently not required even in the case of aggressive media. The surfaces can consequently be exposed directly to the ambient atmosphere.

1-9. (canceled)

10. A device for electrically contacting an electrically conductive part of a high-frequency system comprising at least one metal supporting element, configured to be exposed to the environmental influences, that is produced from bronze.

11. The device as claimed in claim 10, wherein the bronze is a cast bronze.

12. The device as claimed in claim 10, wherein the metal supporting element is one of an electrical connector and a connector part.

13. The device as claimed in claim 12, wherein the connector part is part of a coaxial connector.

14. The device as claimed in claim 10, wherein the metal supporting element is part of a high-frequency lightning protection component.

15. The device as claimed in claim 10, wherein the metal supporting element is an electrical component for an outdoor antenna.

16. The device as claimed in claim 10, wherein the metal supporting element is part of one of a cable gland, a power divider, a high-frequency filter and a high-frequency coupler.

17. The device as claimed in claim 10, wherein the bronze has proportion of zinc less than one of 7% and 6% by weight.

18. The device as claimed in claim 10, wherein the bronze is a multialloy bronze with lead.

19. The device as claimed in claim 10, wherein the bronze has the composition CuZn6Sn4Pb3.
